(19) United States
(12) Patent Application Publication
(10) Pub. No.: US 2013/0174214 A1
(43) Pub. Date: Jul. 4, 2013

(54) Management Tracking Agent for Removable Media

(71) Applicant: Imation Corp., Oakdale, MN (US)

(72) Inventor: David Paul Duncan, Boulder, CO (US)

(73) Assignee: Imation Corp., Oakdale, MN (US)

(21) Appl. No.: 13/727,891

(22) Filed: Dec. 27, 2012

Related U.S. Application Data
(60) Provisional application No. 61/581,333, filed on Dec. 29, 2011.

(51) Int. Cl. G06F 11/30; G06F 21/55

(52) U.S. Cl. CPC G06F 11/3065; G06F 21/556
USPC 726/1; 714/47.1; 714/42; 726/22

(57) ABSTRACT

A management agent stored on removable storage media is operable, when the storage media is coupled with a host device, to, via the host device, track data events and report the data events to a remote management console.

### CROSS-REFERENCE TO RELATED APPLICATIONS

This application claims priority to U.S. Provisional Application No. 61/581,333, filed Dec. 29, 2011, entitled MANAGEMENT TRACKING AGENT FOR REMOVABLE MEDIA, the entirety of which is incorporated by reference herein.

### BACKGROUND

The present disclosure relates to a management tracking agent for removable media. Particularly, the present disclosure relates to a management tracking agent for removable media that may collect information relating to the removable media and/or its use.

### SUMMARY

The present disclosure relates to a management tracking agent or program, in software or firmware, for removable media that may collect information relating to the removable media and/or its use, and may provide remote management functionality. More particularly, the present disclosure relates to a management tracking agent or program which may deployed on removable media and provide, for example, forensics analysis, security policy enforcement, and remote media diagnostic services for removable media.

The present disclosure, in one embodiment, relates to a management agent or program embodied in software or firmware that is installed and stored on a removable storage medium or removable media device. The management agent may be operable, when the storage media is coupled with a host computing device, to, via execution on a processor of the host computing device, track data events and report the data events to a remote management console. The management agent may also provide remote authentication recovery from the remote management console. The management agent may also perform remote media diagnostics and error correction checks at the request of the remote management console. Similarly, the management agent may include a virus signature library and scan data written to the storage media for viruses based on the virus signature library.

The present disclosure, in another embodiment, relates to removable storage media comprising a management agent program stored thereon. The management agent may be operable by execution on a computer processor to track data events and report the data events to a remote management console via a host computing device to which the removable storage media is coupled.

The present disclosure, in yet another embodiment, relates to a method for auditing or policing use of removable storage media. The method may include providing a management agent stored on the storage media, receiving, at a remote location, one or more tracked data events from the management agent, and providing an interface, at the remote location, by which a user may revoke access to specified portions of data on the storage media based on the tracked data events. In some embodiments, the method may also include providing, to the management agent, authentication recovery information stored at the remote location.

The present disclosure, in still another embodiment, relates to a method for reporting data events for removable storage media. The method may include providing a management agent stored on the storage media, tracking data events for the storage media, and reporting the data events to a remote management console via a host computing device to which the removable storage media is coupled. The management agent may also perform media diagnostic and error correction checks at the request of the remote management console, and provide media diagnostic and health status to the remote management console. The method may also include scanning data written to the storage media for viruses.

While multiple embodiments are disclosed, still other embodiments of the present disclosure will become apparent to those skilled in the art from the following detailed description, which shows and describes illustrative embodiments of the disclosure. As will be realized, the various embodiments of the present disclosure are capable of modifications in various aspects, all without departing from the spirit and scope of the present disclosure. Accordingly, the drawings and detailed description are to be regarded as illustrative in nature and not restrictive.

### BRIEF DESCRIPTION OF THE DRAWINGS

FIG. 1 is a block diagram of a management agent for removable media.

FIG. 2 is a block diagram of a method for using the management agent for removable media.

FIG. 3 is a block diagram of the management agent, showing a representative software module or program structure.

### DETAILED DESCRIPTION

The present disclosure relates to novel and advantageous management tracking agents for removable media. Particularly, the present disclosure relates to novel and advantageous management tracking agents for removable media that may collect information relating to the removable media and/or its use and health status, and may provide remote management functionality.

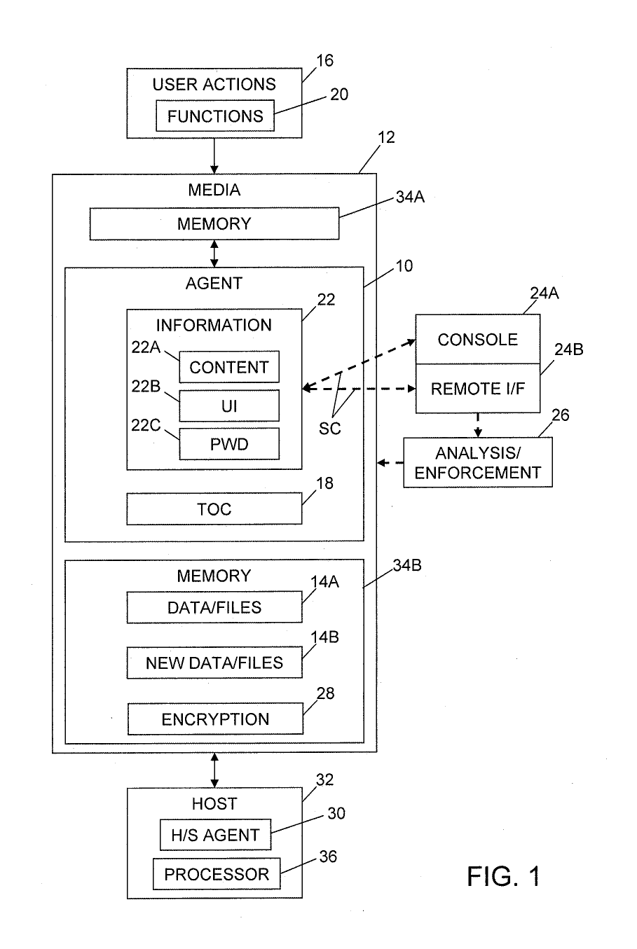

Generally, a management tracking agent 10 (see FIG. 1) may be provided or installed on portable or removable storage media or device 12, such as but not limited to optical storage media (including, for example, CDs, DVDs, and Blu-ray media), magnetic media (including, for example, magnetic tape and magnetic disk media), and removable drives (including, for example, Flash or USB drives, SD cards, compact flash, and other solid state storage devices, and removable or external hard disk drives (HDDs)). The management tracking agent 10 may be software based, although it is recognized that the management tracking agent 10 may be provided utilizing hardware components, or a combination of hardware, firmware and software components or modules. The management tracking agent 10 may collect information about, for example but not limited to, files or data 14A, 14B being written to the storage media 12 and user actions 16 with the storage media and/or the files or data 14A stored thereon. For example, the management tracking agent 10 may detect new data or files 14B written the storage media, may create or maintain a table of contents 18 or other organizational means or listing for tracking or monitoring the data 14A, 14B and/or user interactions 16 with the data or files 14A, 14B, and may record user actions 16 with the data or files 14A, 14B, such as but not limited to open, create, delete, and edit functions, or the like functions 20. The management tracking agent 10 may transmit or report collected information 22 to a management console 24A, including a remote management console or interface 24B, that can provide, for example but not limited to, forensics analysis or security policy enforcement 26 for the storage media 12, and media health and error correction status. For example, data or file content 22A and/or user interactions 22B therewith may be transmitted or reported to a remote management console or interface 24B at a remote location, for forensics analysis or security policy enforcement 26. Additionally, the management tracking agent 10 can provide remote password recovery 22C, for example, in cases where administrator assistance is desired or required to access the storage media 12, such as if the user has encrypted the device or set a password for the storage media 12 and is unable to access the stored data 14A, 14B.

Although the management tracking agent 10 could be particularly designed for operating on a specific media type 12, in one embodiment, the management tracking agent 10 may be configured such that it is not specific to any particular storage media type 12 and may be deployed, in many cases without modification, on a variety of storage media types 12, such as but not limited to, those media types listed above. Additionally, the management tracking agent 10 may be configured for utilization with storage media 12 having any level of encryption 28, ranging from, for example but not limited to, hardware-based encrypted media 12 to media 12 with no encryption 28.

In one embodiment, the management tracking agent 10 may be a general or special purpose software or firmware based agent 10 that can be provided or installed on the storage media 12 in any of a variety of manners. For example, in one embodiment, the management tracking agent 10 may be pre-installed or pre-loaded on the storage media 12, such as by a manufacturer installation process, as will be understood by those skilled in the art. In other embodiments, often referred to as a user installation, a user or administrator may install the management tracking agent 10 on the storage media 12 subsequent to receipt from the manufacturer or agent/distributor of the manufacturer. In yet another embodiment, the management tracking agent 10 may be downloaded and/or installed automatically to the storage media 12, for example but not limited to, based on specified or predetermined policies. For example, the management tracking agent 10 may be downloaded and installed to the storage media 12 automatically when the storage media 12 is detected by a hardware and/or software agent 30 running on a host device 32 to which the storage media 12 is coupled. In still other embodiments, other methods of installation of the management tracking agent 10 to the storage media 12 are within the spirit and scope of the present disclosure.

During installation, the program files and/or data files for the management tracking agent 10 may be stored to a memory 34A of the storage media, which may or may not be accessible to the user, may or may not be overwritten by the user, and may or may not comprise the same memory location 34B provided for storing user data or files 14A, 14B. In one embodiment, the management tracking agent 10 may be run utilizing one or more processors 36 of a host device 32 to which the storage media or medium 12 is coupled.

The management tracking agent 10 may include one or more modules or programs, such as software modules, for providing any portion of the above-described functionality. In some embodiments, the management tracking agent 10 may include one or more software modules or programs for providing one or more of the following functionalities:

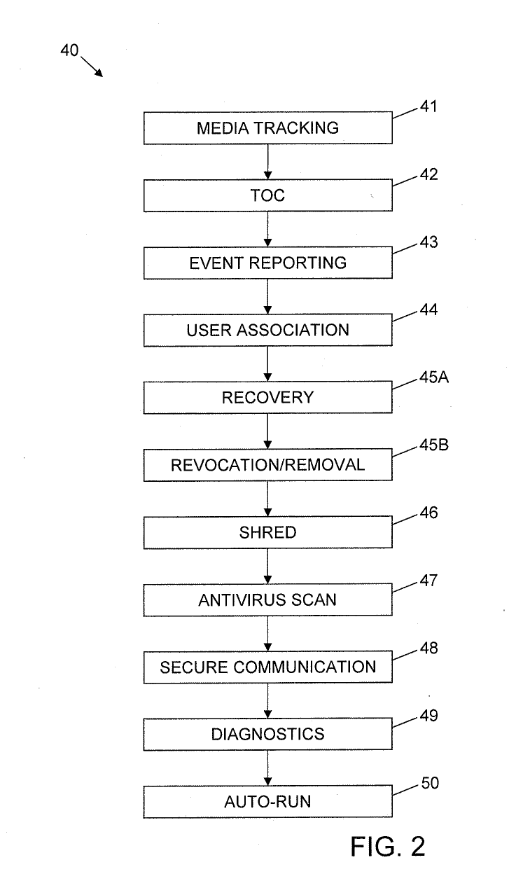

a) Storage device tracking and/or reporting (e.g., method 40 step 41; see FIG. 2). Tracking the storage media device 12 may include tracking or monitoring any suitable or desirable information related to or about the storage media 12 or use of the storage media 12, including, but not limited to, device mount information, host device identification (ID) information, user ID information, IP address, date and/or time, unique device information (such as any unique watermarks), etc. Any tracked or monitored information may be reported to the management console and may be done automatically, as determined by the management tracking agent 10, management console, or other suitable agent, or upon manual instruction or request by a user or administrator, which may be done, for example, via the host device to which the storage media 12 is coupled or via the management console, which may be remotely located.

b) Table of contents creation and/or reporting (step 42). As discussed above, the management tracking agent 10 may create or maintain a table of contents or other organizational means or listing for tracking or monitoring the data and/or user interactions with the data or files. The table of contents, in one embodiment, may include, but is not limited to, a data or file list, data or file creation information, host device ID information related to any data or file or interactions therewith, user ID information related to any data or file or interactions therewith, IP addresses related to any data or file or interactions therewith, date and/or time information related to any data or file or interactions therewith, unique file information (such as any unique watermarks associated with any data or file), etc. Any table of contents information may also be reported to the management console and may be done automatically, as determined by the management tracking agent 10, management console, or other suitable agent, or upon manual instruction or request by a user or administrator, which may be done, for example, via the host device to which the storage media 12 is coupled or via the management console, which may be remotely located.

c) Data or file event reporting (step 43). As indicated above, any data or file event may also be reported to the management console. Data or file events may include, but are not limited to, the writing or creation of new data or files, changes to data or a file, opening of data or a file, modification of data or a file, creation of new data folders or file folders or other organizational schema, deletion of data, a file, or a folder, movement of data, a file, or folder, etc. Data or file event reporting may be done automatically, as determined by the management tracking agent 10, management console, or other suitable agent, and in one embodiment, may be done upon detection of the event or at specified time intervals, for example. In other embodiments, data or file event reporting may be done upon manual instruction or request by a user or administrator, which may be done, for example, via the host device to which the storage media 12 is coupled or via the management console, which may be remotely located,

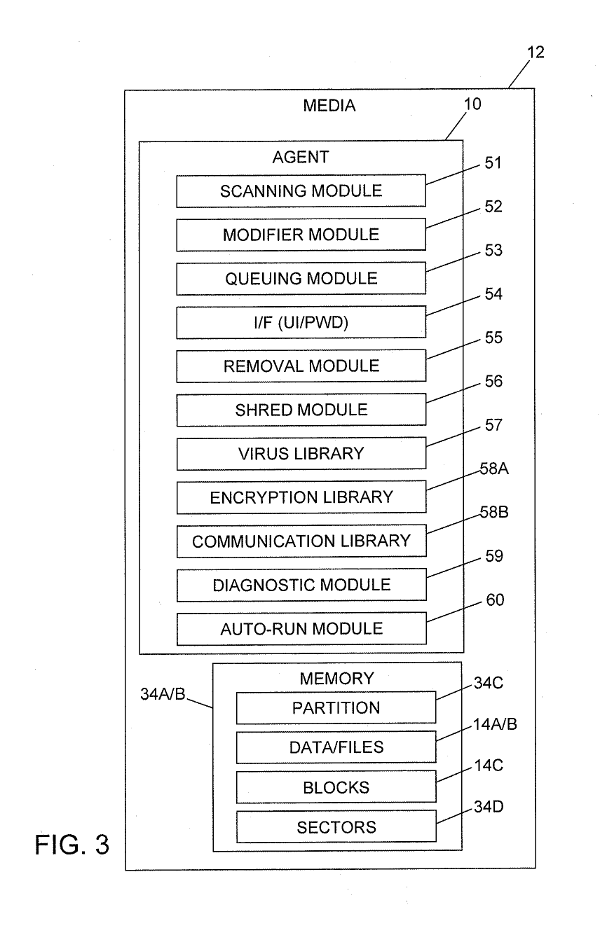

The management tracking agent 10 may include one or more modules, such as software modules or threads, assisting in providing the functionality for data or file event reporting, including but not limited to: a data or file scanning module or thread 51 (FIG. 3), which may be configured for detecting new data or files 14B written to the storage media 12; a data or file modifier module or thread 52, which may be configured for detecting changes to data or files 14A, 14B that are stored on the storage media 12; and a queuing module or thread 53, which may be configured for handling data or file events. The queuing module 53 may operate in any manner understood by those skilled in the art. However, in one embodiment, the queuing module 53 operates according to a first in, first out (FIFO) model.

d) Associate a user to a storage media device (step 44). The management tracking agent 10 may associate a user to a particular storage media device 12 and track any information related to the association, including but not limited to, user ID information, user password information or other authentication information, associated storage media device 12 information or details (including, for example, storage media type, file system type, partition data, etc.). Any association information may be reported to the management console and may be done automatically, as determined by the management tracking agent 10, management console, or other suitable agent, or upon manual instruction or request by a user or administrator, which may be done, for example, via the host device to which the storage media 12 is coupled or via the management console, which may be remotely located.

e) Remote password recovery setup (step 45A). The management tracking agent 10 may include one or more interfaces 54 for a user to set up remote password recovery. For example, the management tracking agent 10 may invoke and provide an interface 54 for receiving user input relating to the password or other authentication information. The password or other authentication information may subsequently be communicated to the management console, and may be done automatically, as determined by the management tracking agent 10, management console, or other suitable agent, or upon manual instruction or request by a user or administrator, which may be done, for example, via the host device to which the storage media 12 is coupled or via the management console, which may be remotely located. The password or other authentication information may thus be stored at the management console for later retrieval when desired or necessary.

f) Remote revocation of a user/password or remote device removal (step 45B). The management tracking agent 10 may provide the ability for a remote user or administrator to direct revocation of user access to, or disablement of user control of, the storage media 12. Revocation may be performed via the remote management console, and may be done manually by a user or administrator or automatically based on, for example, predetermined policies and/or indications of abuse or disobedience with such policies. In one embodiment, revocation may be completed by revoking or disabling the validity of the user password associated with the user and/or storage media 12. In alternative or additional embodiments, the management console may direct the storage media 12 to perform removal operations, such as via operating system (OS) commands to the host device to which the storage media 12 is coupled, thus causing the storage media 12 to be unmounted or removed from the host device OS.

The management tracking agent 10 may include one or more modules, such as software modules or threads, assisting in providing the functionality for remote revocation of user/password or remote device removal, including but not limited to, a device removal module or thread 55. The device removal module 55 may be configured to remove or disable user control of the storage media 12. The device removal module 55 may be utilized by the management console, or for example, by an administrator via the management console, to remove or disable user control of the storage media 12. For example, an administrator may desire or need to revoke access to the storage media 12 either entirely or with respect to a given user and/or a particular partition 34C of the storage media 12.

g) Remote shred of storage media data (step 46). The management tracking agent 10 may provide the ability for a remote user or administrator to direct the shredding, removal, deletion, or the like (collectively referred to herein as shredding) of data or file contents from the storage media 12. Shredding may be performed via the remote management console, and may be done manually by a user or administrator or automatically based on, for example, predetermined policies and/or indications of abuse or disobedience with such policies. In one embodiment, the management tracking agent 10 may be directed to invoke and perform utility functions that delete and/or overwrite specified or all data blocks 14C of the storage media 12. In some embodiments, the management tracking agent 10 may delete and/or overwrite the specified data blocks 14C multiple times to help ensure that data on the device is not recoverable or is relatively difficult to recover from those data blocks 14C.

The management tracking agent 10 may include one or more modules, such as software modules or threads, assisting in providing the functionality for remote shredding, including but not limited to, a data shred module or utility 56. The data shred module 56 may be configured to shred, remove, or delete data or file contents 14A, 14B from the storage media 12, as discussed above. The shred module 56 may be utilized by the management console, or for example, by an administrator via the management console, to remove or delete data 14A, 14B from the storage media 12.

h) Antivirus scanning (step 47). Antivirus scanning may include, but is not limited to, scanning and/or monitoring data or files 14A, 14B written to or stored on the storage media 12 for viruses, such as by scanning and/or monitoring data or files 14A, 14B written to or stored on the storage media 12 for known virus signatures. The management tracking agent 10 may include one or more modules, such as software modules or threads, assisting in providing the functionality for antivirus scanning, such as but not limited to, a known virus signature library 57, which may contain a listing of known virus signatures, and which, in some embodiments, may be updateable as further virus signatures become known. Antivirus scanning may be performed automatically, as determined, for example, by the management tracking agent 10, an antivirus scanning schedule, and/or upon specified events, or upon manual instruction or request by a user or administrator, which may be done, for example, via the host device to which the storage media 12 is coupled or via the management console, which may be remotely located. Any information related to antivirus scanning may be reported to the management console and may be done automatically, as determined by the management tracking agent 10, management console, or other suitable agent, or upon manual instruction or request by a user or administrator, which may be done, for example, via the host device to which the storage media 12 is coupled or via the management console, which may be remotely located.

i) Secure communication with remote management console (step 48). The management tracking agent 10 may report to and/or communicate with the management console by any suitable means. However, in some embodiments, the management tracking agent 10 may report to and/or communicate with the management console utilizing a secure communication channel SC (see FIG. 1). The management tracking agent 10 may include communication libraries and/or encryption capabilities for providing secure communication with the management console. For example, in one embodiment, the management tracking agent 10 may include capabilities for encrypting any reporting data or information and communicating the encrypted data or information securely to the remote management console via a secure communication channel SC.

The management tracking agent 10 may include one or more modules, such as software modules or threads, assisting in providing the functionality for secure communication with the remote management console. For example, the management tracking agent 10 may include an encryption library 58A, which may be configured for encrypting data or file events. The reported data and file events may be encrypted such that they are not modifiable by the user, or for example, at least without appropriate validation or authentication. Additionally, the management tracking agent 10 may include a communication library 58B, which may be configured to communicate device and data or file events to a management or administrator console. In some embodiments, the device and data or file events may be encrypted and communicated to the management console using a secure channel SC created, at least in part, utilizing the communication library 58B. The device and data or file events may be communicated to the management console, in some embodiments, using standard network communication protocols, such as but not limited to, SSL (Secure Sockets Layer) or TCP/IP (Transmission Control Protocol/Internet Protocol).

j) Health diagnostics (step 49). In some embodiments, the management tracking agent 10 may include one or more modules, such as software modules or threads, assisting in diagnosing the health of the removable storage media or device 12. For example, the management tracking agent 10 can invoke an internal function or diagnostic module 59, e.g. on command, that runs a diagnostic check of the media 12, which tests for bad media blocks 14C and/or sectors 34D of the device memory, and which may determine if any data blocks 14C or sectors 34D are corrupted. The management tracking agent 10 may also attempt to repair these blocks 14C and/or sectors 34D, for example using an internal remediation algorithm, if any corruption or other problems are detected. The management tracking agent 10 may also communicate to the remote management server the results of these diagnostic checks, or the overall health and status of the media or device 12 based on these diagnostic checks, and/or the success or failure in remediation of any errors found on the media or device 12. In various embodiments, for example, the management agent 10 may comprise, e.g., within diagnostic module 59, a health and status check and/or error correction algorithm for determining or locating bad sectors 34D or blocks 14C of device memory, or corrupted files or data 14A, 14B on the removable storage media or device 12. The health and status check and/or error correction algorithm may also be operable to repair any one or more bad sectors 34D or blocks 14C of memory, or files or data 14A, 14B stored on the removable media 12 or in the memory of a corresponding removable storage device 12, if, when, and where possible.

k) Auto-run (step 50). In some embodiments, the management tracking agent 10 may include an auto-run module 60, which may be configured to automatically invoke and launch the management tracking agent 10, for example, upon coupling of the storage media 12 to a host device or other access event to the storage media 12.

The present disclosure relates to a management agent stored on removable storage media operable, when the storage media is coupled with a host device, to, via the host device, track data events and report the data events to a remote management console. The present disclosure also relates to removable storage media comprising the management agent. The present disclosure similarly relates to a method for auditing or policing use of removable storage media including providing a management agent stored on the storage media, receiving, at a remote location, one or more tracked data events from the management agent, and providing an interface, at the remote location, by which a user may revoke access to specified portions of data on the storage media based on the tracked data events.

In another embodiment, the present disclosure relates to a method for reporting data events for removable storage media. In a further embodiment, the present disclosure relates to a method for determining the health and status of the removable storage media, running diagnostics and error correction, and reporting the health and status of the removable storage media to a remote management console.

In the foregoing description, various embodiments of the invention have been presented for the purpose of illustration and description. They are not intended to be exhaustive or to limit the invention to the precise form disclosed. Obvious modifications or variations are possible in light of the above teachings. The embodiments were chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

We claim:

1. A non-volatile, removable computer readable storage medium having a management agent comprising at least one program module stored thereon and operable, when the removable storage medium is coupled with a host computing device, to, via execution on a processor of the host computing device, track data events for the removable storage medium and report the data events to a remote management console.

2. The removable storage medium having the management agent of claim 1, wherein the management agent is further operable by execution on the processor to provide remote authentication recovery from the remote management console.

3. The removable storage medium having the management agent of claim 1, the management agent further comprising a virus signature library and operable by execution on the processor to scan data written to the removable storage medium for viruses based on the virus signature library.

4. The removable storage medium having the management agent of claim 1, the management agent further comprising a diagnostic module operable by execution on the processor for diagnosing health of the removable storage medium.

5. The removable storage medium having the management agent of claim 4, wherein the diagnostic module comprises a status check algorithm for determining one or more of bad sectors, bad blocks, corrupted files and corrupted data on the removable storage medium.

6. The removable storage medium having the management agent of claim 5, wherein the diagnostic module further comprises an error correction algorithm for repairing one or more of the bad sectors, bad blocks, corrupted files or corrupted data.

7. A removable storage device comprising the removable storage medium having the management agent of claim 1 stored thereon, the management agent operable by execution on the processor of the host computing device to track the data events and report the data events to the remote management console via the host computing device to which the removable storage medium is coupled.

8. The removable storage device of claim 7, wherein the management agent comprises a secure communication module executable on the processor of the host computing device for secure communications of the data events to the remote management console over a network.

9. The removable storage device of claim 8, wherein the management agent comprises a removal module executable on the processor of the host computing device to revoke user access to the removable storage medium over the network via the remote management console.

10. The removable storage device of claim 7, wherein the management agent further comprises a diagnostic module executable on the processor of the host computing device to run a diagnostic check on the removable medium and to report one or more bad blocks, bad sectors, corrupt files or corrupt data to the remote management console over the network, based on results of the diagnostic check.

11. A method for use of removable storage media, the method comprising:
providing a management agent comprising at least one program module stored on the removable storage media;
executing the management agent program on a computer processor of a host computing device coupled to the removable storage media;
receiving, at a remote location, one or more tracked data events for the removable storage media from the management agent; and
providing an interface, at the remote location, by which a user may revoke access to specified portions of data on the removable storage media based on the tracked data events.

12. The method of claim 11, further comprising, providing to the management agent, authentication recovery information stored at the remote location.

13. A method for reporting data events according to the method of claim 11, further comprising:
tracking the one or more data events for the removable storage media; and
reporting the tracked data events to the remote management console over a network via the host computing device to which the removable storage media is coupled.

14. The method of claim 13, further comprising scanning data written to the removable storage media for viruses.

15. A method comprising
executing a management agent program on a processor of a host computer, the management agent program stored in memory of a removable storage device coupled thereto;
associating a user with the removable storage device;
tracking data events for the removable storage medium, based on interactions of the user with data stored in the memory of the removable storage device;
creating a secure channel for communication of the tracked data events to a remote console at a remote location; and
reporting the tracked data events to the remote console, via the secure channel.

16. The method of claim 15, further comprising:
tracking user information related to the interactions of the user with the data stored in the memory of the removable storage device; and
reporting the user information to the remote console, via the secure channel.

17. The method of claim 16, further comprising revoking access of the user to the data stored in the memory of the removable storage device via the remote console, based on the tracked data events.

18. The method of claim 16, further comprising shredding the data stored in the memory of the removable storage device via the remote console, based on an indication of abuse of a security policy for the removable storage device.

19. The method of claim 15, further comprising running a diagnostic check on the removable storage device to locate one or more of a bad block, bad sector, corrupt file or corrupt data in the memory of the removable storage device.

20. The method of claim 19, further comprising reporting results of the diagnostic check to the remote console via the secure channel.
